(19) United States
(12) Patent Application Publication
(10) Pub. No.: US 2026/0117085 A1
(43) Pub. Date: Apr. 30, 2026

(54) FERMENTED MOLASSES COMPOSITION AND USES

(71) Applicant: Lesaffre et Compagnie, Paris (FR)

(72) Inventor: Xavier LEBRUN, Marquette-Lez-Lille (FR)

(21) Appl. No.: 18/727,948

(22) PCT Filed: Jan. 9, 2023
(86) PCT No.: PCT/FR2023/050026

§ 371 Date: Jul. 10, 2024

(30) Foreign Application Priority Data
Jan. 10, 2022 (FR) 2200132

(51) Int. Cl. C09D 17/00; C09K 8/08; C11D 3/12; C11D 3/22

(52) U.S. Cl. CPC C09D 17/004; C09K 8/08; C11D 3/122; C11D 3/222

(57) ABSTRACT

The invention relates to a composition comprising fermented molasses and at least one colloidal filler having a density of greater than or equal to 1.8 at 20° C. The invention also relates to the use of fermented molasses as a dispersant for a colloidal filler in a dispersion, preferably in a drilling fluid, in a detergent composition or in a pigment paste. The invention also relates to the use of a fermented molasses composition for forming a coating on a surface, wherein the composition comprises at least 35% by weight of dry matter of fermented molasses relative to the total weight of the composition.

### FIELD OF THE INVENTION

The present invention relates to compositions comprising a fermented molasses and a colloidal filler, which can be used in particular as drilling mud, and to a new use of fermented molasses as dispersant.

The present invention further relates to a new use of the fermented molasses as a coating of a surface, in particular to reduce the permeability thereof to fluids, gases and/or greases.

### TECHNOLOGICAL BACKGROUND

Aqueous drilling muds, used to drill wells in a rock formation, generally use surfactants derived from the oil industry to stabilize colloidal dispersions of barite. Such dispersions make it possible to increase the density of the water and thus the pressure during deep drilling for oil extraction or for geothermics.

However, such drilling muds have a significant environmental footprint and the use thereof results in the release of toxic substances into the direct environment of the drilling.

Molasses is a co-product coming from making sugar, conventionally from beet and cane in sugar factories, or from brown sugars in refineries. The process of making sugar, whether from cane or beet, leads, after the crystallization step, to the production of sugar on the one hand and of molasses on the other.

Although used to extract glycine betaine, which, after esterification, is used as a surfactant, beet molasses are, like cane molasses, more generally used for animal feed, mixed with straw or other cellulosic foodstuff, and also as a binder in complete animal rations, or to promote the ingestion of unappetizing foodstuff in animals.

As an alternative to animal feed, molasses is also used by manufacturers for the production of so-called “noble” products via fermentation processes. Indeed, through the fermentation mechanisms certain microorganisms have, molasses can serve as a substrate and can be used in particular to obtain baker's yeast, ethyl alcohol, citric and glutamic acids, lysine or again antibiotics.

On the other hand, the use of molasses via fermentation processes generates large quantities of liquid fermentation residues. The liquid fermentation residues correspond to the so-called fermented molasses.

Having been depleted in constituents by micro-organisms, fermented molasses is generally considered a fermentation residue of low interest, and is mainly used in the field of agriculture as spreading fertilizer.

EP 0495856 relates to aqueous drilling fluids comprising an extract of a natural substance having a high proportion of monosaccharides and/or oligosaccharides, in particular a sugarcane extract, a beet extract and/or a malted grain extract, intended to limit the swelling or disintegration of drilled rock in contact with aqueous drilling fluid, in particular for shale formations. The sugar cane and beet extracts may more particularly be cane molasses, beet molasses or condensed molasses solids.

Document GB 2380502 relates to drilling fluids comprising solids of desugared molasses and an alkyl glucoside for improving the stability of drilling, more particularly when the drilled rock comprises shale.

There is a real need to provide dispersions of a solid filler in a liquid medium, that are stable and environmentally friendly, while remaining economical.

Moreover, in the field of drilling muds, used to drill wells in a rock formation, it is common to add fluid loss control agents (or filtration reducers) to the muds, to prevent the penetration of drilling mud filtrates into the rock formation.

There is also a real need to provide a composition that is, at the same time, economical, environmentally friendly and simple to prepare, having clogging and/or film-forming properties which can be used in various applications.

### SUMMARY OF THE INVENTION

The invention relates firstly to a composition comprising a fermented molasses and at least one colloidal filler having a density greater than or equal to 1.8 at 20° C.

In embodiments, the fermented molasses is a fermented beet molasses and/or a fermented cane molasses.

In embodiments, the fermented molasses is a fermented cane molasses.

In embodiments, the colloidal filler is selected from the group consisting of barite, calcium carbonate, carbon black, pigments, calcium sulfate, iron oxide, titanium dioxide, fruit core powders, kaolin, colloidal silica particles, talc, clays, lime, magnesium oxide, aluminum oxide, yeast walls, and combinations thereof.

In embodiments, the at least one colloidal filler has a density greater than or equal to 2.5 at 20° C.

In embodiments, the at least one colloidal filler has a density greater than or equal to 4 at 20° C.

According to one embodiment, the composition further comprises from 35 to 80% by weight, preferably from 60 to 80% by weight of fermented molasses, with respect to the total weight of the composition.

According to one embodiment, the composition further comprises from 20 to 65% by weight, preferably from 20 to 40% by weight of colloidal filler with a density greater than or equal to 1.8, with respect to the total weight of the composition.

In embodiments, the composition comprises a concentration of water from 20 to 70% by weight, preferably from 30 to 50% by weight, relative to the total weight of the composition.

In embodiments, the fermented molasses comprises a concentration of dry matter from 50 to 90% by weight, preferably 50 to 65% by weight.

In embodiments, the composition further comprises at least one brine, preferably comprising a salinity of 100 to 350 g/l.

In embodiments, the composition has a pH of from 2 to 12.5, preferably from 8 to 12.5.

In embodiments, the composition is a drilling mud.

In embodiments, the composition is a detergent composition.

In embodiments, the composition is a pigment paste.

The invention further relates to the use of a fermented molasses as dispersant of a colloidal filler in a dispersion, preferably in a drilling mud, in a detergent composition or in a pigment paste.

The present invention according to such first subject matter serves to meet the need expressed hereinabove. The invention provides more particularly a composition that is, at the same time, economical, non-toxic and environmentally friendly, wherein a filler can be stably dispersed. Such compositions may be useful in particular as drilling muds, detergent creams or pigment pastes.

The hereinabove is accomplished through the use of fermented molasses in the composition. It has been discovered that, surprisingly, fermented molasses intrinsically has surfactant properties which, when mixed with a solid filler of a certain density, form a dispersion, the fermented molasses being able to play the role both of the aqueous medium of the dispersion and of the surfactant. In addition, for certain applications, such as drilling mud applications, fermented molasses can also replace viscosifying agents.

Secondly, the invention relates to the use of a fermented molasses composition for forming a coating on a surface, wherein the composition comprises at least 35% by weight of fermented molasses dry matter, relative to the total weight of the composition.

In embodiments, the coating is a film that reduces permeability to a substance, the substance preferably being chosen from the group consisting of water, gases, greases, and combinations thereof.

In embodiments, the fermented molasses is a fermented beet molasses and/or a fermented cane molasses.

In embodiments, the quantity of fermented molasses dry matter, relative to the total weight of the fermented molasses composition, is from 40 to 90% by weight, preferably from 50 to 65% by weight.

In embodiments, the composition of fermented molasses has a concentration of water greater than or equal to 10% by weight, preferably from 10 to 60% by weight, more preferentially from 35 to 50% by weight, relative to the total weight of the composition.

In embodiments, the fermented molasses composition comprises from 20 to 40% by weight of at least one colloidal filler, preferably selected from the group consisting of barite, calcium carbonate, carbon black, pigments, calcium sulfate, iron oxide, titanium dioxide, fruit core powders, kaolin, colloidal silica particles, talc, clays, lime, magnesium oxide, aluminum oxide, yeast walls, and combinations thereof, more preferentially the colloidal filler is barite.

In embodiments, the fermented molasses composition consists of fermented molasses dry matter and water.

In embodiments, the fermented molasses composition has a pH of from 2 to 13, preferably from 5 to 11.

In embodiments, the surface is the surface of a rock of subterranean formation.

In embodiments, the surface is a hydraulic binder, preferably cement.

In embodiments, the surface is a material comprising cellulose fibers, such as paper or cardboard, woven fabric and/or non-woven fabric.

The invention further relates to an object covered at least in part with a coating comprising at least 35% by weight of fermented molasses dry matter.

The present invention according to the second subject matter makes it possible to meet the need expressed hereinabove. More particularly, the invention provides a composition which can be used for forming a coating on various surfaces, more particularly for reducing the permeability of said surface to fluids, gases and/or greases, which is non-toxic and environmentally-friendly while remaining economical and simple to prepare and to use.

The hereinabove is accomplished by using fermented molasses in the composition so that the composition has a certain quantity of fermented molasses dry matter. It has been discovered that, surprisingly, such fermented molasses has good sealing and film-forming properties. Furthermore, in advantageous embodiments, the fermented molasses can be used directly, as is, without requiring, in particular, a step of formulation from various additives, which simplifies the preparation of the coating composition and reduces the energy consumption required for the coating composition. In addition, compared to the use of synthetic polymers as sealing agents or fluid loss control agents, the use of fermented molasses is more environmentally friendly.

### BRIEF DESCRIPTION OF FIGURES

FIG. 1 shows the backscattering spectra of light recorded at different times, between 0 and 24 h, for a composition of fermented molasses of pure cane at 60° C. as described in example 2 hereinbelow. The height of the tube containing the composition (in mm) is shown on the abscissa and the percentage of backscattering of the light is shown on the ordinate.

FIG. 2 shows the backscattering spectra of light recorded at different times, between 0 and 24 h, for a composition of fermented cane molasses comprising 20% by weight of barite at 40° C. as described in example 2 hereinbelow. The height of the tube containing the composition (in mm) is shown on the abscissa and the percentage of backscattering of the light is shown on the ordinate.

FIG. 3 shows the backscattering spectra of light recorded at different times, between 0 and 24 h, for a composition of fermented cane molasses comprising 20% by weight of barite at 60° C. as described in example 2 hereinbelow. The height of the tube containing the composition (in mm) is shown on the abscissa and the percentage of backscattering of the light is shown on the ordinate.

FIG. 4 shows the backscattering spectra of light recorded at different times, between 0 and 24 h, for a composition of fermented cane molasses comprising 30% by weight of barite at 40° C. as described in example 2 hereinbelow. The height of the tube containing the composition (in mm) is shown on the abscissa and the percentage of backscattering of the light is shown on the ordinate.

FIG. 5 shows the backscattering spectra of light recorded at different times, between 0 and 24 h, for a composition of fermented cane molasses comprising 30% by weight of barite at 60° C. as described in example 2 hereinbelow. The height of the tube containing the composition (in mm) is shown on the abscissa and the percentage of backscattering of the light is shown on the ordinate.

FIG. 6 shows the backscattering spectra of light recorded at different times, between 0 and 24 h, for a composition of fermented cane molasses comprising 40% by weight of barite at 40° C. as described in example 2 hereinbelow. The height of the tube containing the composition (in mm) is shown on the abscissa and the percentage of backscattering of the light is shown on the ordinate.

FIG. 7 shows the percentage of backscattering of light as a function of time (in hours), at the height of the measuring tube between 33 and 42 mm, for the composition of fermented cane molasses comprising 20% by weight of barite at 40° C. (curve A, symbols X), the fermented cane molasses composition comprising 20% by weight barite at 60° C. (curve B, symbols ♦), the fermented cane molasses composition comprising 30% by weight barite at 40° C. (curve C, symbols ▴), the fermented cane molasses composition comprising 30% by weight of barite at 60° C. (curve D, symbols ▪) and the fermented cane molasses composition comprising 40% by weight of barite at 40° C. (curve E in dotted lines).

FIG. 8 shows the light backscattering spectra recorded at different times, between 0 and 24 h, for the regenerated sample of fermented cane molasses comprising 30% by weight of barite at 40° C. as described in example 2 hereinbelow. The height of the tube containing the composition (in mm) is shown on the abscissa and the percentage of backscattering of the light is shown on the ordinate.

FIG. 9 shows the percentage of backscattering of light as a function of time (in hours) at the height of the measuring tube between 33 and 42 mm for the first fermented cane molasses composition comprising 30% by weight of barite at 40° C. (Curve F, symbols ▴), for the second sample containing 30% barite at 40° C. (curve G, dashed) and for the sample regenerated at 40° C. (curve H) as described in example 2 hereinbelow.

FIG. 10 shows the backscattering spectra of light recorded at different times, between 0 and 19 h10, for dispersion No. 1 as described in example 3 hereinbelow. The height of the tube containing the composition (in mm) is shown on the abscissa and the percentage of backscattering of the light is shown on the ordinate.

FIG. 11 shows the backscattering spectra of light recorded at different times, between 0 and 19 h10, for dispersion No. 2 as described in example 3 hereinbelow. The height of the tube containing the composition (in mm) is shown on the abscissa and the percentage of backscattering of the light is shown on the ordinate.

FIG. 12 shows the percentage of backscattering of light as a function of time (in hours), at the height of the measuring tube comprised between 33 and 42 mm, for dispersion No. 1 (curve I) and for dispersion No. 2 (curve J, dark gray, symbols w) as described in example 3 hereinbelow, as well as for the first composition of fermented cane molasses comprising 30% by weight of barite at 40° C. (curve K, symbols ▴) and for the second sample containing 30% barite at 40° C. (curve L, in dotted lines) as described in example 2 hereinbelow.

FIG. 13 shows the backscattering spectra of light recorded at different times, between 0 and 24 h, for the initial composition (before aging) of fermented cane molasses comprising 40% by weight of barite at 60° C., as described in example 4 hereinbelow. The height of the tube containing the composition (in mm) is shown on the abscissa and the percentage of backscattering of the light is shown on the ordinate.

FIG. 14 represents the backscattering spectra of the light recorded at different times, between 0 and 23 h, for the composition of fermented cane molasses comprising 40% by weight of barite at 60° C., after aging at 4° C. for 48 h, as described in example 4 hereinbelow. The height of the tube containing the composition (in mm) is shown on the abscissa and the percentage of backscattering of the light is shown on the ordinate.

FIG. 15 shows the backscattering spectra of light recorded at different times, between 0 and 24 h, for the composition of fermented cane molasses comprising 40% by weight of barite at 60° C., after aging at 8° C. for 48 h, as described in example 4 hereinbelow. The height of the tube containing the composition (in mm) is shown on the abscissa and the percentage of backscattering of the light is shown on the ordinate.

FIG. 16 shows the backscattering spectra of light recorded at different times, between 0 and 24 h, for the composition of fermented cane molasses comprising 40% by weight of barite at 60° C., after aging at 120° C. for 48 h, as described in example 4 hereinbelow. The height of the tube containing the composition (in mm) is shown on the abscissa and the percentage of backscattering of the light is shown on the ordinate.

### DETAILED DESCRIPTION

The invention is now described in greater detail and in a non-limiting manner in the following description.

In the present text, unless otherwise expressly stated, all the percentages (%) indicated are percentages by weight.

In the present text, the quantities indicated for a given species may apply to said species according to all the definitions the species (as mentioned in the present text), including the narrower definitions.

Composition with Colloidal Filler

According to a first subject matter, the invention relates to a composition comprising a fermented molasses and at least one colloidal filler.

In a particularly preferred manner, the composition according to the invention is a dispersion (or colloidal suspension), i.e. a suspension of the colloidal filler dispersed in a liquid phase. As defined by the present invention, “colloidal suspension” or “dispersion” refers to the dispersion of filler particles uniformly distributed in the continuous medium (the liquid phase). The uniform distribution can be checked by microscopic observation. Preferably, the distribution of particles in the dispersion is uniform when the distribution of particle sizes, by volume, is single-peak, and more particularly when same is according to a Gaussian function. The particle size distribution can be determined by laser diffraction particle size distribution. Preferably, the colloidal filler particles have a size of less than or equal to 10 μm, more preferentially less than or equal to 5 μm. Particle size can be measured by dynamic light scattering. Preferably, the composition according to the invention is an aqueous dispersion.

In the present text, “fermented molasses” means fermented molasses that have not undergone an esterification process (e.g. to esterify glycine betaine present in a fermented beet molasses).

As mentioned hereinabove, fermented molasses is a co-product of molasses obtained after fermentation of the latter by bacteria, yeasts or fungi, said fermentation making it possible e.g. to obtain so-called “noble” products such as baker's yeast, ethyl alcohol, citric acid or glutamic acid.

The fermented molasses used in the invention may be a fermented beet molasses or a fermented cane molasses. The fermented molasses used in the invention may alternatively be a mixture of fermented beet molasses and fermented cane molasses. For example, the mixture may comprise from 1 to 25% by weight of fermented beet molasses and from 75 to 99% by weight of fermented cane molasses, or from 25 to 50% by weight of fermented beet molasses and from 50 to 75% by weight of fermented cane molasses, or from 50 to 75% by weight of fermented beet molasses and from 25 to 50% by weight of fermented cane molasses, or from 75 to 99% by weight of fermented beet molasses and from 1 to 25% by weight of fermented cane molasses.

More preferably, the fermented molasses used is a fermented cane molasses. The use of fermented cane molasses makes it possible to obtain a dispersion with better kinetic stability than the use of fermented beet molasses.

Advantageously, the fermented molasses is obtained by fermentation of molasses with yeasts.

Preferably, the fermented molasses incorporated in the composition according to the invention comprises a dry matter content of 50 to 90% by weight, preferably from 50 to 65% by weight, more preferentially from 52 to 56% by weight. More particularly, the fermented molasses may comprise from 50 to 52% by weight, or from 52 to 56% by weight, or from 56 to 58% by weight, or from 58 to 60% by weight, or from 60 to 62% by weight, or from 62 to 65% by weight, or from 65 to 70% by weight, or from 70 to 75% by weight, or from 75 to 80% by weight, or from 80 to 85% by weight, or from 85 to 90% by weight, of dry matter. Preferably, the rest of the fermented molasses is water (the fermented molasses incorporated in the composition may thus comprise from 10 to 50% by weight of water, preferably from 35 to 50% by weight of water, more preferentially from 44 to 48% by weight of water).

The fermented molasses recovered at the end of the fermentation bath generally contains from 5 to 10% by weight of dry matter (and hence from 90 to 95% by weight of water). Fermented molasses, as recovered after the fermentation process, may undergo concentration, in order to reduce the quantity of water, or dilution, preferably with water, e.g. to achieve a dry matter content in one of the ranges mentioned hereinabove.

The fermented molasses incorporated in the composition may be a demineralized fermented molasses. The demineralization may e.g. consist of precipitation of potassium sulfate salts (K₂SO₄), sodium sulfate (Na₂SO₄), magnesium sulfate (MgSO₄) and calcium sulfate (CaSO₄) by addition of sulfuric acid. Advantageously, demineralization increases the proportion of organic matter in fermented molasses and increases the proportion of surfactant molecules in molasses relative to the total dry matter in the fermented molasses.

The fermented molasses incorporated in the composition may be a depotassified fermented molasses, e.g. by acidification with a sulfuric acid solution followed by a neutralization with ammonia.

Alternatively, the fermented molasses used for the preparation of the composition may be a fermented molasses known as “crude”, i.e. same has not been subjected to any chemical or physical and chemical treatment (the crude fermented molasses may, however, have been concentrated or diluted).

A fermented molasses can be defined by the distribution thereof in nitrogenous materials and by the aminogram thereof. The fermented molasses according to the invention can thereby have a distribution of nitrogenous materials as follows:
Nitrogen of total amino acids determined by the Kjeldahl method: 25% to 100% by weight of total nitrogen,
betaine nitrogen: 0% to 50% by weight of total nitrogen,
ammoniacal nitrogen: 0% to 30% by weight of total nitrogen.

More particularly, the fermented molasses according to the invention may have a distribution of nitrogenous materials as hereinafter, especially when a fermented beet molasses is considered:
nitrogen of total amino acids determined by the Kjeldahl method: 25% to 50% by weight total nitrogen,
betaine nitrogen: 40% to 50% by weight of total nitrogen,
ammoniacal nitrogen: 2% to 3% by weight of total nitrogen.

Alternatively, the fermented molasses according to the invention may have a distribution of nitrogenous materials as hereinafter, more particularly when a fermented cane molasses is considered:
nitrogen of total amino acids determined by the Kjeldahl method: 70% to 100% by weight of total nitrogen,
ammoniacal nitrogen: 0% to 30% by weight of total nitrogen.

As regards the aminogram of the proteins of the fermented molasses according to the invention, the average amino acid contents may be as follows (the ranges of contents are given in g/kg of dry matter of the fermented molasses):
aspartic acid: 6-8;
threonine: 0.5-3;
serine glutamic acid: 115-130;
proline: 3-4;
glycine: 4-5;
alanine: 2.5-3.5;
valine: 2.5-3.5;
methionine and cysteine: 0.5-3;
isoleucine: 1.5-2.5;
tyrosine: 2-3.5;
leucine: 3-4.5;
phenylalanine: 1-2;
lysine: 0.5-2.5;
histidine: 0.5-2; and
arginine: 0.2-1.

Fermented molasses has a low content of sugars, the latter having been consumed by the microorganisms during the fermentation process. “Low sugar content” means that the sugar content is less than or equal to 5% by weight, or less than or equal to 4% by weight, or less than or equal to 3% by weight, or less than or equal to 2% by weight, and preferably less than or equal to 1% by weight, relative to the total mass of the fermented molasses dry extract. More preferentially, the fermented molasses according to the invention is free of sugars.

The fermented molasses according to the invention can have a density at 20° C. of 1.10 to 1.50, preferably of 1.20 to 1.40, more particularly of 1.25 to 1.35. The density of fermented molasses can be determined using a DMA 4500M density meter from Anton Paar at a temperature of 20° C. on a 2 ml sample.

The fermented molasses according to the invention may have a kinematic viscosity at 20° C., of 50 to 6000 MPa·s, preferably from 500 to 5000 MPa·s, more preferably from 1000 to 4000 MPa·s. Viscosity can be measured using a Brookfield viscometer at a temperature of 20° C. and a shear rate of 20 s−1.

The fermented molasses incorporated in the composition according to the invention may have a pH of 2 to 12.

The composition according to the invention comprises at least one colloidal filler. “Colloidal filler” refers to any solid substance in the form of particles. In the present text, the terms “colloidal filler” and “filler” have the same meaning and are used interchangeably. The colloidal filler has a density greater than or equal to 1.8 at 20° C. In the context of the present invention, the density of the filler should be understood as being the packed density. The density of the filler can be determined at a temperature of 20° C. according to the standard ISO 787-11.

The colloidal filler may be inorganic or organic.

Preferably, the colloidal filler is a mineral filler.

The colloidal filler may be a density agent, a pigment, a detergent, an abrasive or exfoliating agent, an active ingredient, or combinations thereof.

Advantageously, the colloidal filler is chosen from the group consisting of barite (BaSO₄) (density at 20° C. of 4.5), calcium carbonate (CaCO₃) (density at 20° C. of 2.7), carbon black (density at 20° C. of 1.8 to 2.1) and other pigments, calcium sulfate (density at 20° C. of 2.9), iron oxide, titanium dioxide (density 3.8-4.3), fruit kernel powder (such as apricot kernel powder), kaolin, colloidal silica particles, talc, clays, lime, magnesium oxide (or magnesia), aluminum oxide, yeast walls, and combinations thereof.

The presence, in the composition, of a filler, and more particularly of a density agent, such as barite, makes it possible to increase the density of the composition. The use of a density agent is particularly useful when the composition is a drilling mud.

In advantageous variants, the colloidal filler has a density at 20° C. greater than or equal to 2.5. In other advantageous variants, the colloidal filler has a density at 20° C. greater than or equal to 4. The colloidal filler may have a density greater than or equal to 2, or greater than or equal to 2.7, or greater than or equal to 2.8, or greater than or equal to 3, or greater than or equal to 3.2, or greater than or equal to 3.5 or greater than or equal to 4.5. More particularly, the filler may have a density at 20° C. of 1.8 to 2, or of 2 to 2.5, or of 2.5 to 3, or of 3 to 3.5 or of 3.5 to 4, or of 4 to 4.5, or of 4.5 to 5, or of 5 to 6.

The composition according to the invention may comprise a filler consisting of a colloidal filler as described hereinabove, according to all the definitions of same, e.g. a colloidal filler having a density greater than or equal to 1.8 at 20° C., or greater than or equal to 2.5 at 20° C., or greater than or equal to 4 at 20° C. In other words, in such embodiments, the composition according to the invention is devoid of colloidal filler not corresponding to said definition (e.g., devoid of colloidal filler having a density of less than 1.8 at 20° C., or of colloidal filler having a density of less than 2.5, or of colloidal filler having a density of less than 4).

Advantageously, the quantity of fermented molasses in the composition according to the invention is from 5 to 95% by weight, preferably from 35 to 80% by weight, preferably from 40 to 80% by weight, else preferably from 55 to 80% by weight, else preferably from 60% to 80% by weight, else preferably from 65% to 75% by weight, more preferentially from 68% to 72% by weight, relative to the total weight of the composition. Alternatively, the quantity of fermented molasses in the composition according to the invention may advantageously be from 5 to 15% by weight, preferably from 5 to 10% by weight, relative to the total weight of the composition. In embodiments, the quantity of fermented molasses in the composition may be from 5 to 10% by weight, or from 10 to 15% by weight, or from 15 to 20% by weight, or from 20 to 25% by weight, or 25 to 30% by weight, or from 30 to 35% by weight, or from 35 to 40% by weight, or from 40 to 45% by weight, or from 45 to 50% by weight, or from 50 to 55% by weight, or from 55 to 60% by weight, or from 60 to 65% by weight, or from 65 to 68% by weight, or from 68 to 70% by weight, or from 70 to 72% by weight, or from 72 to 75% by weight, or from 75 to 80% by weight, or from 80 to 85% by weight, or from 85 to 90% by weight, or from 90 to 95% by weight, relative to the total weight of the composition.

Preferably, the composition comprises a quantity of colloidal filler having a density at 20° C. greater than or equal to 1.8, from 5 to 95% by weight, else preferably from 20 to 65% by weight, else more preferentially from 20 to 60% by weight, else preferentially from 20 to 45% by weight, else preferentially from 20 to 40% by weight, more preferentially from 25 to 35% by weight, else more preferentially from 28 to 32% by weight, relative to the total weight of the composition. Alternatively, the composition may comprise a quantity of colloidal filler having a density at 20° C. greater than or equal to 1.8, from 40 to 95% by weight, e.g. from 40 to 50% by weight, or from 90 to 95% by weight. In embodiments, the composition may comprise, relative to the total weight of the composition, from 5 to 10% by weight, or from 10 to 15% by weight, or from 15 to 20% by weight, or from 20 to 25% by weight, or from 25 to 28% by weight, or from 28 to 30% by weight, or from 30 to 32% by weight, or from 32 to 35% by weight, or from 35 to 40% by weight, or from 40 to 45% by weight, or from 45 to 50% by weight, or from 50 to 55% by weight, or from 55 to 60% by weight, or from 60 to 65% by weight, or from 65 to 70% by weight, or from 70 to 75% by weight, or from 75 to 80% by weight, or from 80 to 85% by weight, or from 85 to 90% by weight, or from 90 to 95% by weight, of colloidal filler. Such quantities may be applied to the filler according to the invention according to all of the definitions of the filler (as mentioned in the present text), including narrower definitions.

Preferably, the composition comprises at least 5% by weight, more preferentially at least 10% by weight, else more preferentially at least 12% by weight, more particularly at least 15% by weight of water, with respect to the total weight of the composition. For example, the composition may comprise from 20 to 70%, preferably 30 to 50% by weight, else preferably 35 to 45% by weight of water, with respect to the total weight of the composition. In embodiments, the composition may comprise, relative to the total weight of the composition, from 5 to 10% by weight, or from 10 to 15% by weight, or from 15 to 20% by weight, or from 20 to 25% by weight, or from 25 to 30% by weight, or from 30 to 35% by weight, or from 35 to 40% by weight, or from 40 to 45% by weight, or from 45 to 50% by weight, or from 50 to 55% by weight, or from 55 to 60% by weight or from 60 to 65% by weight or from 65 to 70% by weight of water.

The composition may comprise a dry matter content of 30 to 80% by weight, preferably from 50 to 70% by weight, more preferably from 55 to 65% by weight, relative to the total weight of the composition.

Preferably, the composition comprises a quantity of fermented molasses dry matter of 30 to 70% by weight, more preferably from 45 to 60% by weight, relative to the total weight of the composition. The composition according to the invention may comprise a quantity of fermented molasses dry matter of 30 to 35% by weight, or 35 to 40% by weight, or 40 to 45% by weight, or 45 to 50% by weight, or from 50 to 55% by weight, or from 55 to 60% by weight, or from 60 to 65% by weight, or from 65 to 70% by weight, relative to the total weight of the composition.

The composition according to the invention can comprise at least one brine. “Brine” refers to an aqueous solution comprising at least one salt. Advantageously, the brine has a salinity greater than or equal to 100 g/l, e.g. from 100 to 350 g/l, and more preferentially greater than or equal to 200 g/l (e.g. from 200 to 350 g/l). The salinity of the brine is defined herein as the total concentration of inorganic salts dissolved in the aqueous solution, preferably in water, such as e.g. NaCl, CaCl₂), MgCl₂, and/or any other inorganic salt. Salinity can be measured using a conductivity probe and is expressed in g/l of total dissolved solids.

The incorporation of a brine into the composition reduces the density of the composition. The incorporation of a brine can be more particularly useful when the composition is a drilling mud, same serves to adjust the density of the mud according to the formation wherein drilling takes place.

Advantageously, the brine is fed into the composition according to the invention in a quantity of 0 to 40% by weight, preferably from 10 to 30% by weight, relative to the total weight of the composition. More particularly, the composition may comprise from 0 to 5% by weight, or from 5 to 10% by weight, or from 10 to 15% by weight, or from 15 to 20% by weight, or from 20 to 25% by weight, or from 25 to 30% by weight, or from 30 to 35% by weight, or from 35 to 40% by weight, of brine, relative to the total weight of the composition.

Other aqueous solutions may also be present in the composition according to the invention.

The composition may consist of fermented molasses and at least one colloidal filler having a density at 20° C. greater than or equal to 1.8 (or a colloidal filler according to the invention having a narrower definition, as described in the present text). Alternatively, the composition may consist of fermented molasses, at least one colloidal filler having a density at 20° C. greater than or equal to 1.8 (or a colloidal filler according to the invention having a narrower definition, as described in the present text) and at least one brine.

Again alternatively, the composition may comprise one or a plurality of other surfactants, e.g. chosen from the group consisting of sorbitans and derivatives thereof, alkyl polyglucosides, sucro esters, glycine betaine esters, rhamnolipids, surfactins, sophorolipids, glycolipids, beet pectins, phospholipids, lecithins, quaternary amines and derivatives thereof, fatty amines and amides, chitosan and derivatives thereof, and soaps and derivatives thereof. Said surfactants may be present in the composition in a quantity from 0% to 10% by weight, preferably from 0% to 2% by weight.

Advantageously, the composition is devoid of surfactants other than fermented molasses, more particularly same is devoid of surfactants as mentioned hereinabove.

The composition may comprise one or a plurality of additives, in particular one or a plurality of hydrocolloids such as xanthan gums, celluloses and cellulose derivatives, pectins, alginates and/or starches.

The composition advantageously has a pH ranging from 2 to 12.5, preferably from 8 to 12.5. The composition may have a pH from 2 to 3, or from 3 to 4, or from 4 to 5, or from 5 to 6, or from 6 to 7, or from 7 to 8, or from 8 to 9, or from 9 to 10, or from 10 to 11, or from 11 to 12, or from 12 to 12.5.

The composition according to the invention preferably has a density at 20° C. of 1 to 2.5, else preferably from 1.2 to 1.8. The density of the composition may be measured as indicated hereinabove for fermented molasses.

The composition according to the invention can be prepared by mixing fermented molasses with at least one colloidal filler and, if appropriate, the other constituents of the composition (such as at least one brine, one or a plurality of other aqueous solutions, other surfactants and/or additives). Mixing can be carried out in one step (all constituents being added to the mixture simultaneously) or in a plurality of steps (some constituents being premixed first before other constituents are added). Preferably, the colloidal filler is added to the fermented molasses, more preferentially with stirring.

The fermented molasses and colloidal filler (and optionally the other constituents of the composition) can be mixed using a deflocculating paddle stirring system, a high shear mixer, or any other mechanical stirring system.

The mixing may be carried out for a period of 1 minute to 1 h, preferably for 2 minutes to 30 minutes, more preferentially for 3 minutes to 15 minutes.

The composition according to the invention can be prepared at room temperature (i.e. between 15 and 30° C.). Alternatively, the fermented molasses, the filler, or both can be heated to a temperature of 60° C. prior to the mixing thereof. More particularly, the constituents of the composition according to the invention can advantageously be mixed at a temperature of 20 to 60° C.

The composition according to the invention can be used in any type of application.

The composition according to the invention may advantageously be a drilling mud. In such embodiments, the colloidal filler preferably has a density at 20° C. greater than or equal to 2.5 and the colloidal filler is preferably barite. The fermented molasses is preferably a fermented cane molasses.

The density of the drilling mud can be varied depending on the tank and/or the depth of the drilling, e.g., by adjusting the quantity of colloidal filler and/or brine added to the fermented molasses.

The composition according to the invention can be used in a large number of other industries or sectors, e.g. in the detergent and cleaning product industry or in the dye industry.

Thus, the composition according to the invention may be a detergent composition. In such embodiments, the colloidal filler preferably has a density at 20° C. greater than or equal to 2.5 and the colloidal filler is preferably chosen from calcium carbonate, fruit core powders, such as apricot kernel powder or combinations thereof.

Alternatively, the composition according to the invention may be a pigment paste. In such embodiments, the colloidal filler preferably has a density at 20° C. greater than or equal to 1.8 and the colloidal filler is preferably carbon black.

The invention further relates to the use of a composition as described hereinabove, as a drilling mud, or as a detergent composition, or as a pigment paste, or for the preparation of a drilling mud, or of a detergent composition, or of a pigment paste.

The invention further relates to the use of fermented molasses as dispersant. Preferably, fermented molasses is used as a dispersant of a filler in a dispersion. More preferentially, the filler may be a filler as described hereinabove, and more particularly may have a density at 20° C. greater than or equal to 1.8. Alternatively, the filler may have a density at 20° C. of less than 1.8. The fermented molasses and the dispersion may be as described hereinabove.

Advantageously, the dispersion wherein the fermented molasses according to the invention is used is a drilling mud, or a detergent composition or a pigment paste.

### Fermented Molasses Composition for Forming a Coating

According to a second subject matter, the invention relates to the use of a fermented molasses composition to form a coating on a surface. Thus, the invention relates to a fermented molasses composition, i.e. a composition comprising (or consisting essentially of, or consisting of) a fermented molasses. The composition according to the invention is advantageously an aqueous composition (i.e. a containing water).

The term “fermented molasses” conventionally refers to the aqueous liquid composition of fermented molasses, but in the context of the subject matter of the present invention, same may also refer to the dry matter of fermented molasses.

The fermented molasses used in the invention may be a fermented beet molasses or a fermented cane molasses. The fermented molasses used in the invention may alternatively be a mixture of fermented beet molasses and fermented cane molasses. For example, the mixture may comprise from 1 to 25% by weight of fermented beet molasses and from 75 to 99% by weight of fermented cane molasses, or from 25 to 50% by weight of fermented beet molasses and from 50 to 75% by weight of fermented cane molasses, or from 50 to 75% by weight of fermented beet molasses and from 25 to 50% by weight of fermented cane molasses, or from 75 to 99% by weight of fermented beet molasses and from 1 to 25% by weight of fermented cane molasses. Preferably, the fermented molasses is a fermented cane molasses.

Advantageously, the fermented molasses is obtained by fermentation of molasses with yeasts.

The fermented molasses may be a demineralized fermented molasses and/or a depotassified fermented molasses, or a so-called “crude” fermented molasses, more particularly as described hereinabove in the section “Composition with colloidal filler”.

The fermented molasses according to the invention may have a distribution of nitrogenous materials and an aminogram as described hereinabove in the section “Composition with colloidal filler”.

Fermented molasses has a low sugar content, more particularly as described hereinabove in the section “Composition with colloidal filler”.

The composition according to the invention comprises a content fermented molasses dry matter greater than or equal to 35% by weight, relative to the total weight of the composition. Preferably, the quantity of fermented molasses dry matter in the composition is equal to 40 to 90%, else preferably 45 to 75% by weight, more preferentially 50 to 65% by weight of, with respect to the total weight of the composition. The composition according to the invention may comprise a quantity of fermented molasses dry matter (relative to the total weight of the composition) equal to 35 to 40% by weight, or from 40 to 45% by weight, or from 45 to 50% by weight, or from 50 to 55% by weight, or from 55 to 60% by weight, or from 60 to 65% by weight, or from 65 to 70% by weight, or from 70 to 75% by weight, or from 75 to 80% by weight, or from 80 to 85% by weight, or from 85 to 90% by weight.

The composition according to the invention advantageously comprises water, in a concentration of less than 65% by weight relative to the total weight of the composition, and more preferentially a water concentration of 10 to 60% by weight, else more preferentially of 35 to 50% by weight, relative to the total weight of the composition. More particularly, the water content of the composition may be from 10 to 15% by weight, or from 15 to 20% by weight, or from 20 to 25% by weight, or from 25 to 30% by weight, or from 30 to 35% by weight, or from 35 to 40% by weight, or from 40 to 45% by weight, or from 45 to 50% by weight, or from 50 to 55% by weight, or from 55 to 60% by weight, or from 60 to less than 65% by weight, relative to the total weight of the composition.

In embodiments, the composition according to the invention may comprise at least one colloidal filler. Preferably, the colloidal filler has a density at 20° C. greater than or equal to 1.8, else preferably greater than or equal to 2.5, more preferentially greater than or equal to 4. The colloidal filler is advantageously as described hereinabove in the section “Composition with colloidal filler”.

When the composition comprises at least one colloidal filler, the latter is preferably present in a quantity ranging from 15% to 65% by weight, else preferably from 15% to 60% by weight, else preferably from 20% to 40% by weight, more preferentially from 25 to 35% by weight, relative to the total weight of the composition; for example, same is present in a quantity of 15 to 20% by weight, or from 20 to 25% by weight, or from 25 to 30% by weight, or from 30 to 35% by weight, or from 35 to 40% by weight, or from 40 to 45% by weight, or from 45 to 50% by weight, or from 50 to 55% by weight, or from 55 to 60% by weight, or from 60 to 65% by weight.

In the embodiments wherein the composition comprises one or a plurality of colloidal fillers, the composition advantageously comprises a water content of 10 to 45% by weight, preferably from 20 to 40% by weight, relative to the total weight of the composition.

The composition according to the invention may comprise inorganic salts such as e.g. NaCl, CaCl₂) and/or MgCl₂. Said inorganic salts can e.g. be provided by incorporating a brine into the fermented molasses composition for the preparation thereof.

The composition may comprise one or a plurality of surfactants, more particularly as described hereinabove in the section “Composition with colloidal filler”. Said surfactants may be present in the composition in a quantity from 0% to 10% by weight, preferably from 0% to 2% by weight. Alternatively, and advantageously, the composition is devoid of surfactants as mentioned hereinabove.

The composition may comprise one or a plurality of other additives, more particularly one or a plurality of hydrocolloids, such as xanthan gums, celluloses, pectins, alginates and/or starches. Advantageously, the composition according to the invention is devoid of the additives mentioned hereinabove.

The composition may comprise one or a plurality of other fluid loss control agents added in addition to the fermented molasses, such as cellulose derivatives, more particularly carboxymethylcellulose and/or polyanionic cellulose, starches and/or synthetic polymers. Preferably, however, the composition is devoid of fluid loss control agents other than fermented molasses dry matter.

In embodiments, the composition consists essentially of, or consists of, fermented molasses, i.e. fermented molasses dry matter and water.

The composition preferably has a pH ranging from 2 to 13, else preferably from 5 to 11. The composition may have a pH from 2 to 3, or from 3 to 4, or from 4 to 5, or from 5 to 6, or from 6 to 7, or from 7 to 8, or from 8 to 9, or from 9 to 10, or from 10 to 11, or from 11 to 12, or from 12 to 13.

The composition according to the invention preferably has a density at 20° C. of 1 to 2.5, else preferably from 1.2 to 1.8.

The fermented molasses incorporated in the composition according to the invention (and which may in embodiments consist of the composition) preferably comprises a dry matter content of 50 to 90% by weight, preferably of 50 to 65% by weight, more preferentially from 52 to 56% by weight. More particularly, the fermented molasses may comprise from 50 to 52% by weight, or from 52 to 56% by weight, or from 56 to 58% by weight, or from 58 to 60% by weight, or from 60 to 62% by weight, or from 62 to 65% by weight, or from 65 to 70% by weight, or from 70 to 75% by weight, or from 75 to 80% by weight, or from 80 to 85% by weight, or from 85 to 90% by weight, of dry matter. Preferably, the rest of the fermented molasses is water (the fermented molasses incorporated in the composition may thus comprise from 10 to 50% by weight of water, preferably from 35 to 50% by weight of water, more preferentially from 44 to 48% by weight of water).

Fermented molasses, as recovered after the fermentation process, may undergo concentration, in order to reduce the quantity of water, or dilution, preferably with water, e.g. to achieve a dry matter content in one of the ranges mentioned hereinabove.

In other embodiments, the composition according to the invention can be prepared from fermented molasses dry matter, more particularly in powder form. The dry matter is then preferably mixed with an aqueous solution, in particular water, and, if appropriate, with other constituents of the composition.

The composition may be prepared by incorporating at least one brine therein. Advantageously, the brine has a salinity greater than or equal to 100 g/l, e.g. from 100 to 350 g/l, and more preferentially greater than or equal to 200 g/l (e.g. from 200 to 350 g/l).

Other aqueous solutions may also be incorporated into the composition according to the invention.

When the composition comprises constituents other than fermented molasses, such as colloidal filler(s), brine, other aqueous solution(s), other surfactants or fluid loss control agents and/or additives, same can be prepared by mixing the fermented molasses with the other constituents of the composition. Mixing can be carried out in one step (all constituents being added to the mixture simultaneously) or in a plurality of steps (some constituents being premixed first before other constituents are added). When the composition comprises a colloidal filler, the latter is preferably added to the fermented molasses, more preferentially with stirring. Mixing of fermented molasses and other components of the composition may be carried out using a deflocculating paddle stirring system, a high shear mixer, or any other mechanical stirring system. The mixing may be carried out for a period of 1 minute to 1 h, preferably 2 minutes to 30 minutes, more preferentially 3 minutes to 15 minutes. The composition according to the invention can be prepared at room temperature (i.e. between 15 and 30° C.). Alternatively, fermented molasses, or one or a plurality of the other constituents (e.g. filler), or all constituents, may be heated to a temperature of 60° C. prior to the mixing thereof. More particularly, the constituents of the composition according to the invention can advantageously be mixed at a temperature of 20 to 60° C.

According to the present subject matter of the invention, the composition is used to form a coating on a surface. The surface may be fully or partially coated.

The coating may have a thickness of 0.1 mm to 30 cm, e.g. 0.1 to 1 mm, or from 1 to 50 mm, or from 50 to 100 mm, or from 100 to 35,500 mm, or from 500 to 1 cm, or from 1 to 5 cm, or from 5 to 10 cm, or from 10 to 15 cm, or from 15 to 20 cm or from 20 to 30 cm.

In a particularly preferred manner, the coating is a film reducing permeability to a substance, more particularly to water, gases and/or greases. The ability to reduce permeability to a substance is determined by measuring the permeability to said substance, of a coated substrate, using an appropriate method, measuring the permeability to said substance, of the uncoated substrate using the same method, and comparing the two values. If the permeability of the substrate coated with the coating is lower than the permeability of the substrate alone, the coating reduces the permeability to said substance.

Advantageously, the coating is a film which reduces the permeability to water. The permeability to water can be measured by a method suited to the substrate on which the coating is deposited, as is well known to a person skilled in the art. More particularly, when the substrate is paper or cardboard, the permeability to water can be determined by the Cobb method (standard ISO 535:2014); when the substrate is soil, the permeability to water can be determined by a so-called “double ring” test, e.g. according to the standard NF X30-418. Preferably, the coating has a permeability to water of less than or equal to 10 g of water/m², preferably less than or equal to 8 g of water/m², else preferably less than or equal to 5 g of water/m². In embodiments, the coating is an impermeable or substantially impermeable coating.

The coating may be a film reducing permeability to gas, and more particularly, a film reducing permeability to water vapor. Permeability to water vapor can be measured as per the standard ASTM E96/E96M. Preferably, the coating is a film with permeability to water vapor or moisture vapor transmission rate (MVTR) at 23° C., at a relative humidity of 50%, is less than or equal to 100 g/m²/24 h, else preferably less than or equal to 50 g/m²/24 h. The coating may be a gas barrier film. The coating may advantageously be a film reducing the permeability to greases.

The permeability to greases can be measured according to the TAPPI/Kit Test method as per the standard ISO 16532-2:2007. Advantageously, the coating has a permeability to greases measured according to the TAPPI/Kit Test method, of less than or equal to 10. The coating may be a grease barrier film.

The surface coated with the fermented molasses composition may be any type of surface, and in particular any type of surface the permeability of which to a substance is to be reduced, more particularly the permeability to water, gases and/or greases.

In embodiments, the covered surface of the liner may be a rock surface, and more particularly a surface of subterranean formation rocks. Thereby, the composition according to the invention is particularly useful in the field of hydrocarbon extraction, to form a coating on the rock wall of a well, in order to limit, or even prevent, the infiltration of fluids from aqueous drilling muds through the rock wall. Advantageously, the composition can be used as a drilling mud, the composition forming a coating on the rock wall when used as a drilling mud. Alternatively, the composition can be used as a sealant in wells already experiencing fluid losses, i.e. to reduce fluid losses during subsequent drilling mud uses.

Alternatively, the surface coated with the fermented molasses composition may be the surface of a hydraulic binder, more particularly a so-called “fresh” (i.e. not hardened) hydraulic binder. The hydraulic binder may be any type of hydraulic binder, e.g. a cement. Hydraulic binders are binders that harden by hydrating, i.e. by reaction with water. The use of a composition according to the invention to cover the surface with a fresh hydraulic binder makes it possible to reduce the dehydration of the hydraulic binder during the hardening step, and thereby to preserve in the binder enough water for sufficient hydration (and thus a hardening) of the latter.

Alternatively, the surface may be made of a material comprising cellulose fibers, e.g. paper or cardboard, woven fabric and/or non-woven fabric, such as leather. The coating makes it possible to reduce the water permeability of said material, or even to make same impermeable to water.

The coating may be applied in a manner known to a person skilled in the art, depending on the application for which same is intended. In embodiments, the fermented molasses composition may be applied to the surface by spraying, soaking/immersion, coating by any suitable tool, or by any other suitable means.

The coating may be applied at ambient temperature or at a higher temperature, more particularly at a temperature comprised between 15 and 120° C.

Once the composition has been coated on the surface, at least some of the water in the composition can be removed, e.g. by evaporation, flow or any other means.

The invention further relates to coating method for a surface, comprising the following steps:
the supply of a fermented molasses composition comprising at least 35% by weight of fermented molasses dry matter;
and
the application of the said composition over the surface.

The characteristics described hereinabove in relation to the use of the composition for coating a surface can be applied in the same way to the coating process.

According to another aspect, the invention relates to the use of a composition comprising at least 35% by weight of fermented molasses dry matter to form a film reducing the permeability to a substance, preferably reducing the permeability to water, gases (more particularly water vapor) and/or greases, preferably on a surface, more preferentially by forming a coating on said surface.

According to another aspect, the invention relates to the use of a composition comprising at least 35% by weight of fermented molasses dry matter to reduce the permeability of a surface to a substance (in particular water, gases and/or greases), preferably through the formation of a coating on said surface. The reduction of the permeability to a substance can be determined as indicated hereinabove.

According to another aspect, the invention relates to the use of a composition comprising at least 35% by weight of fermented molasses dry matter to reduce the permeability to water of a surface, preferably through the formation of a coating on said surface.

According to another aspect, the invention relates to the use of a composition comprising at least 35% by weight of fermented molasses dry matter to reduce the permeability of a surface to gases (more particularly to water vapor), preferably by through the formation of a coating on said surface.

According to another aspect, the invention relates to the use of a composition comprising at least 35% by weight of fermented molasses dry matter to reduce the permeability to greases of a surface, preferably through the formation of a coating on said surface.

According to another aspect, the invention relates to the use of fermented molasses as permeability reducing agent in a composition, said composition comprising at least 35% by weight of fermented molasses dry matter. As defined by the present invention, the expression “permeability reducing agent in a composition” preferably means that, when the composition, at a temperature of 60° C., is filtered according to the standard API RP 13B, for 30 minutes, under a pressure of 0.6-0.7 MPa on a cellulose ester membrane having a pore size between 1 and 10 μm, the mass of filtrate obtained is less than or equal to 12 g.

According to another aspect, the invention relates to a drilling mud consisting essentially of, or consisting of, fermented molasses comprising at least 35% by weight of dry matter. The invention also relates to the use of a composition consisting essentially of, or consisting of, a fermented molasses comprising at least 35% by weight of dry matter, as drilling mud.

According to another aspect, the invention relates to an object covered at least in part with a coating (or film) comprising at least 35% by weight of fermented molasses dry matter. The coating may comprise at least 40% by weight of fermented molasses dry matter, or at least 50% by weight of fermented molasses dry matter, or at least 60% by weight of fermented molasses dry matter, or at least 70% by weight of fermented molasses dry matter, or at least 80% by weight of fermented molasses dry matter, or at least 90% by weight of fermented molasses dry matter, or consist of fermented molasses dry matter. The coating preferably has a thickness of 0.1 mm to 30 cm. The object covered with the coating may be, more particularly, a sheet of paper, a sheet of cardboard, an object made of hydraulic binder, a wall of subterranean formation, an insulation board, more particularly of wood, a woven fabric, a non-woven fabric, a woven filter or a non-woven filter.

What has been described hereinabove in relation to the use of the composition for coating a surface can be applied to the other aspects of the invention described in the present section.

### EXAMPLES

The following examples illustrate the invention without limiting same.

### Example 1—Density Measurement

Three dispersions comprising different quantities of barite were prepared as follows: an appropriate quantity of barite powder was added to a quantity of 25 g of molasses fermented with magnetic stirring (using a magnetic bar) at 1200 rpm for 3 minutes at room temperature. The fermented molasses used is a fermented cane molasses comprising about 55% by weight of dry matter. No other compound was added to the compositions. The quantities of barite introduced into the fermented molasses are such that the compositions comprise 20% by weight of barite, 30% by weight of barite and 40% by weight of barite, respectively.

A comparative composition not comprising any barite (and thus comprising only fermented molasses) was also prepared.

The density of the compositions was measured using a DMA@ 4500M densimeter from Anton Paar at a temperature of 60° C. on a 2 ml sample.

The results obtained are presented in the table hereinbelow:

TABLE 1

| Quantity (in % by weight) of | Density of the |
|---|---|
| barite in the composition | composition at 60° C. |
| 0 | 1.32051 |
| 20 | 1.51323 |
| 30 | 1.64812 |
| 40 | 1.78602 |

### Example 2—Turbidity Measurement

Turbidity measurements were carried out on dispersions of barite in the fermented molasses to detect the extent of sedimentation of barite particles over a period of 24 h. The measurements were carried out with a Turbiscan@ Lab apparatus using static multiple light scattering. The head of the apparatus moves along the height of the measuring cell and records the light transmission for transparent samples and the backscattering of light for opaque samples. The apparatus receives signals every 40 μm and at different time periods. The samples are stored in thermal chambers. Creaming and sedimentation can be evaluated by viewing the signals from the TURBISCAN@ Lab. Sedimentation results in a decrease in backscattering at the top of the tube containing the sample since a clarification and an increase in backscattering of light at the bottom of the tube take place, due to particles that have sedimented. The opposite situation is observed in the case of creaming (the backscatter signal increases at the top of the tube due to creaming and decreases at the bottom of the tube due to clarification).

The dispersions of fermented cane molasses comprising different proportions of barite, and the comparative dispersion comprising only fermented cane molasses, as described in example 1 hereinabove, were stored in tubes in the Turbiscan Lab for 24 h at 40° C. (for dispersions comprising 20, 30 or 40% of barite) and 60° C. (for dispersions comprising 20 or 30% of barite), the tubes being regularly scanned. The samples were opaque and no light transmission could be detected. Thereby, the measurements were limited to the backscattered light.

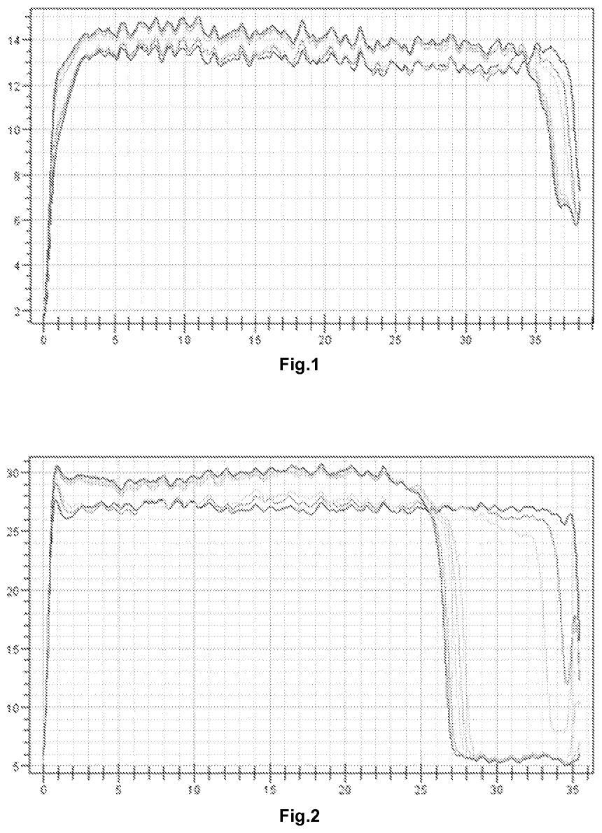

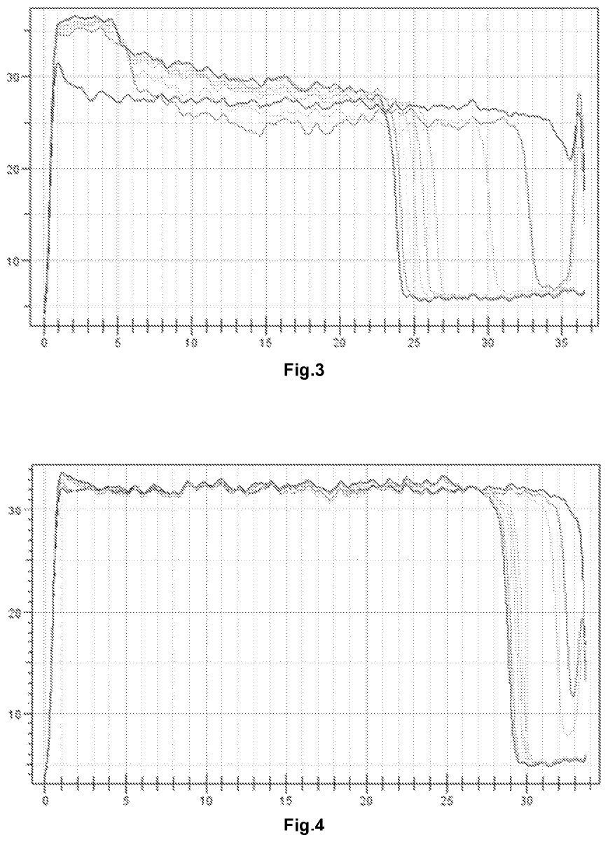

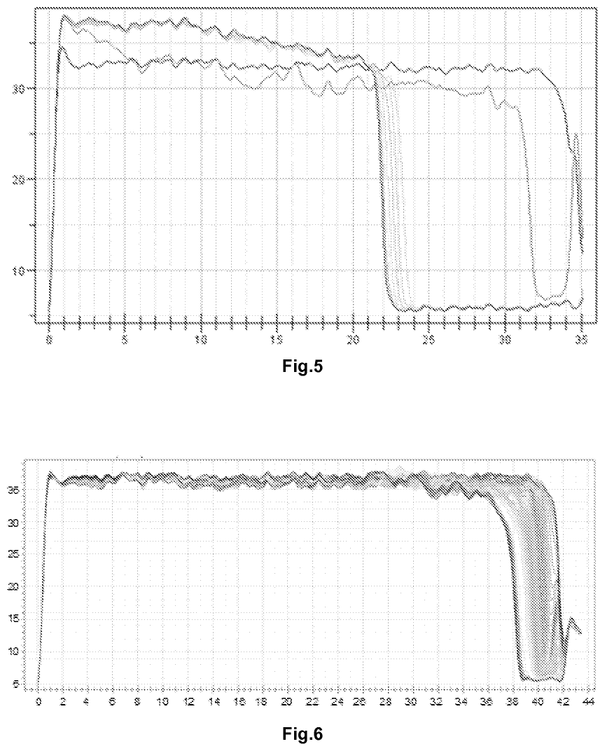

Spectra (with the exception of the spectra for pure fermented molasses at 40° C.) obtained after different periods of time, up to 24 h, are shown in FIG. 1, FIG. 2, FIG. 3, FIG. 4, FIG. 5 and FIG. 6.

Pure fermented molasses is stable at 40° C. and 60° C., with no change in the backscattering observed. In dispersions comprising barite, a significant increase in light scattering is observed throughout the tube, indicating that the solid particles of barite have been well dispersed in the fermented molasses. Said particles settled slightly, leading to clarification at the top of the tube. However, no increase in backscattering was observed at the bottom of the tubes, meaning that no phase separation occurred. The barite particles remained generally well dispersed.

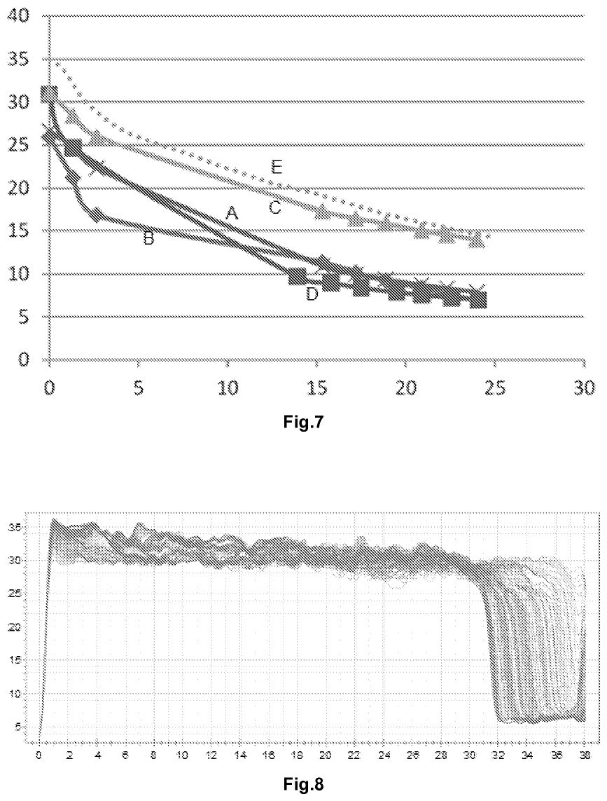

The rate of clarification, for each of the compositions tested (with the exception of the pure fermented molasses compositions), is shown in FIG. 7.

Clarification is found to be faster at 60° C. than at 40° C.

It is also observed that, at 40° C., the dispersions are more stable when the quantity of barite increases.

A second sample comprising 30% by weight of barite and 70% by weight of fermented cane molasses (referred to as the “second 30% barite sample”) was prepared in the same way as the first sample comprising 30% by weight of barite described hereinabove and was stored at 40° C. for 24 h. The second sample containing 30% barite was again subjected, after clarification, to stirring as initially applied and the backscattering of the light of said sample, called the “regenerated sample”, was measured at 40° C. for 24 h. The spectra of the regenerated sample are shown in FIG. 8.

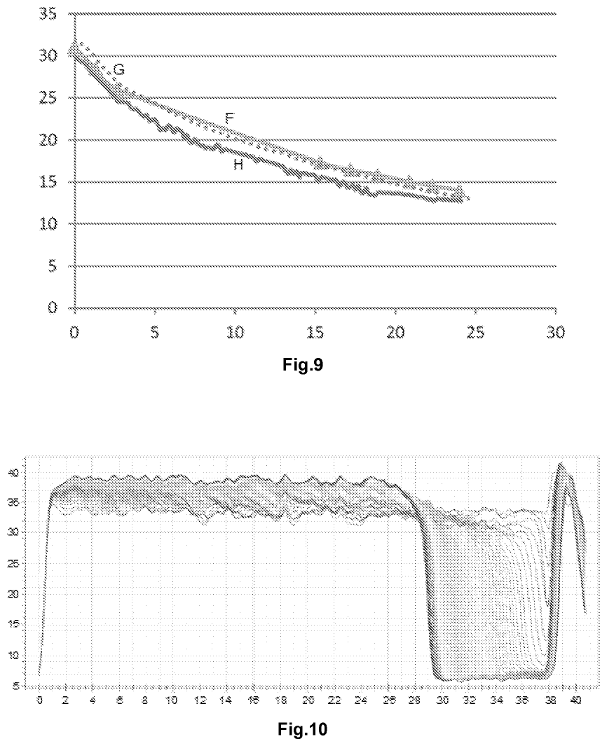

The clarification rate (at 40° C.) of the second 30% barite sample and the regenerated sample were also measured and the results are presented in FIG. 9. It was found that the curve of the second sample containing 30% barite is superimposed on the curve of the first sample containing 30% by weight of barite. Furthermore, the curve of clarification rate of the regenerated sample is almost superimposed on same of the second 30% barite sample (from which the regenerated sample was prepared).

In the regenerated sample, the barite, which had slightly sedimented beforehand, dispersed well, confirming the good dispersal properties of the fermented cane molasses.

### Example 3—Dispersions with Brine

The compatibility of mixtures of barite and fermented molasses with a brine consisting of distilled water containing 300 g/l CaCl₂) has been evaluated.

To this end, the brine was fed into a dispersion comprising 30% by weight of barite in the fermented cane molasses, in a quantity of 20% by weight of the total composition. The brine was fed into the dispersion at room temperature and with magnetic stirring. A sample of said dispersion (dispersion No. 1) was adjusted to a pH of 7 and another sample (dispersion No. 2) was adjusted to a pH of 10. To prepare dispersion No. 2, an aqueous sodium hydroxide solution was added to the fermented molasses until a pH of 10 was obtained.

The density of dispersions No. 1 and No. 2 was determined as indicated in example 1, but at temperatures of 20° C., 40° C. and 60° C., and the results are presented in the table hereinbelow.

TABLE 2

| Dispersion No. | Density at 20° C. | Density at 40° C. | Density at 60° C. |
|---|---|---|---|
| 1 (pH 7) | 1.51971 | 1.51158 | 1.50377 |
| 2 (pH 10) | 1.50251 | 1.49501 | 1.48626 |

The turbidity of the dispersions was also measured at 40° C. by a Turbiscan® Lab apparatus in the way indicated in example 2 hereinabove

The spectra obtained after different periods of time, up to a duration of 19 h10, are shown in FIG. 10 and FIG. 11.

No phase separation was observed for the two dispersions No. 1 at (pH 7) and dispersion No. 2 (at pH 10), the dispersions are relatively stable.

It was found that dispersion No. 2 at pH 10 has a better stability than dispersion No. 1 at pH 7, the dispersing properties of the fermented molasses are improved at pH 10 compared to pH 7.

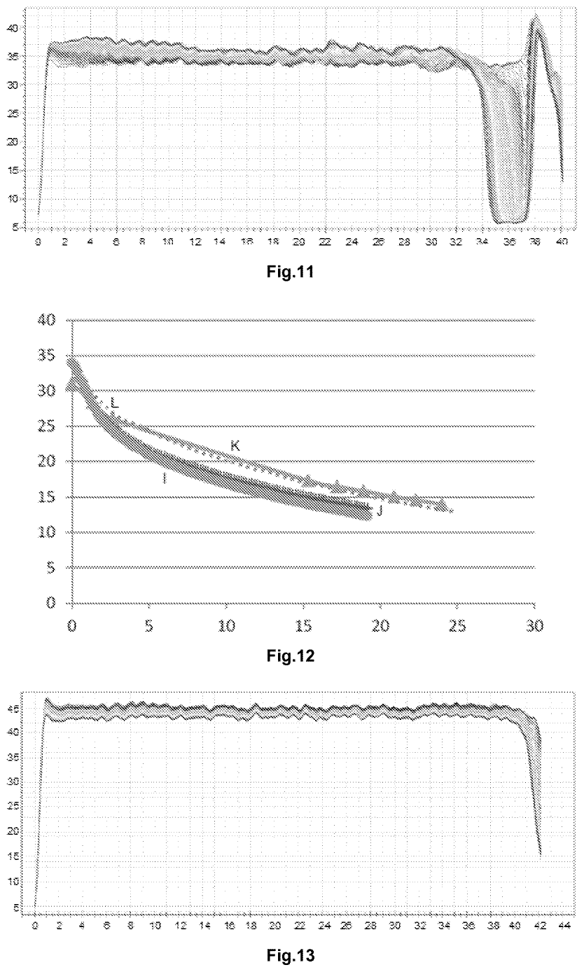

The rate of clarification of dispersions No. 1 and No. 2 is illustrated in FIG. 12.

The Turbiscan® Stability Index (TSI) is a parameter used by formulators to characterize the stability of a formulation. TSI is a dimensionless number which is the result of the sum of all destabilization phenomena occurring in the sample that can be measured by a significant change in the signal intensity in backscattering or transmission over the height of the sample. Said index is obtained by the Turbiscan® Lab turbidimeter. The lower the TSI, the more stable the sample.

The TSI was determined for each of the products described hereinabove and the results are presented in the table hereinbelow.

TABLE 3

| | Quantity of | Quantity of | | |
|---|---|---|---|---|
| | barite in the | brine in the | Temperature | |
| | composition | composition | of the | |
| | (% by | (% by | composition | |
| Composition | weight) | weight) | (° C.) | TSI |
| Fermented cane | 0 | 0 | 40 | 0.7 |
| molasses | | | | |
| Fermented cane | 0 | 0 | 60 | 1.4 |
| molasses | | | | |
| Fermented | 20 | 0 | 40 | 7.5 |
| molasses + | | | | |
| barite | | | | |
| Fermented | 20 | 0 | 60 | 10 |
| molasses + | | | | |
| barite | | | | |
| Fermented | 30 | 0 | 40 | 5 |
| molasses + | | | | |
| barite | | | | |
| Fermented | 30 | 0 | 60 | 12 |
| molasses + | | | | |
| barite | | | | |
| 2nd sample | 30 | 0 | 40 | 6 |
| containing 30% | | | | |
| barite | | | | |
| Regenerated | 30 | 0 | 40 | 11 |
| sample (molasses | | | | |
| fermented + | | | | |
| barite) | | | | |
| Fermented | 40 | 0 | 40 | 6 |
| molasses + | | | | |
| barite | | | | |
| Dispersion No. 1 | 24 | 20 | 40 | 12 |
| (fermented | | | | |
| molasses + | | | | |
| barite + | | | | |
| brine, pH 7) | | | | |
| Dispersion No. 2 | 24 | 20 | 40 | 7 |
| (fermented | | | | |
| molasses + | | | | |
| barite + | | | | |
| brine, pH 10) | | | | |

### Example 4—Thermal Stability

Five dispersions comprising 60% by weight of barite were prepared in the manner indicated in example 1, except that the pH of the fermented molasses used to prepare the dispersions was adjusted to 10 beforehand, by adding sodium hydroxide granules to the fermented molasses with stirring.

The five dispersions were aged for 48 h at temperatures of 4° C., 5° C., 8° C., 100° C. and 120° C., respectively, as follows:
aging at 4° C.: under static conditions, in a cold room;
aging at 5° C., 100° C. and 120° C.: under dynamic conditions (100 s−1), in a rheometer pressure cell;
aging at 8° C.: under static conditions, in a refrigerator.

For aging experiments at high temperatures (100° C. and 120° C.), the cell was set under a pressure of 35 bar under nitrogen to avoid the evaporation of the water and to mimic the operating conditions of the boreholes.

The density of dispersions aged at 5° C., 8° C., 100° C. and 120° C., as well as the density of the dispersion before aging, were measured by weighing a precise volume of dispersion.

The results obtained are presented in the table hereinbelow:

TABLE 4

| | Density of the |
|---|---|
| Dispersion | dispersion at 25° C. |
| Dispersion before aging | 1.9906 |
| Dispersion aged at 5° C. | 2.0129 |
| Dispersion aged at 8° C. | 2.0563 |
| Dispersion aged at 100° C. | 2.0094 |
| Dispersion aged at 120° C. | 2.054 |

It is found that the densities of the dispersions remain relatively constant after aging at low and high temperatures.

The turbidity of the dispersions aged at 4° C., 8° C. and 120° C. and of the initial dispersion (before aging) was also measured at 60° C. by a Turbiscan® Lab apparatus in the way indicated in example 2 hereinabove.

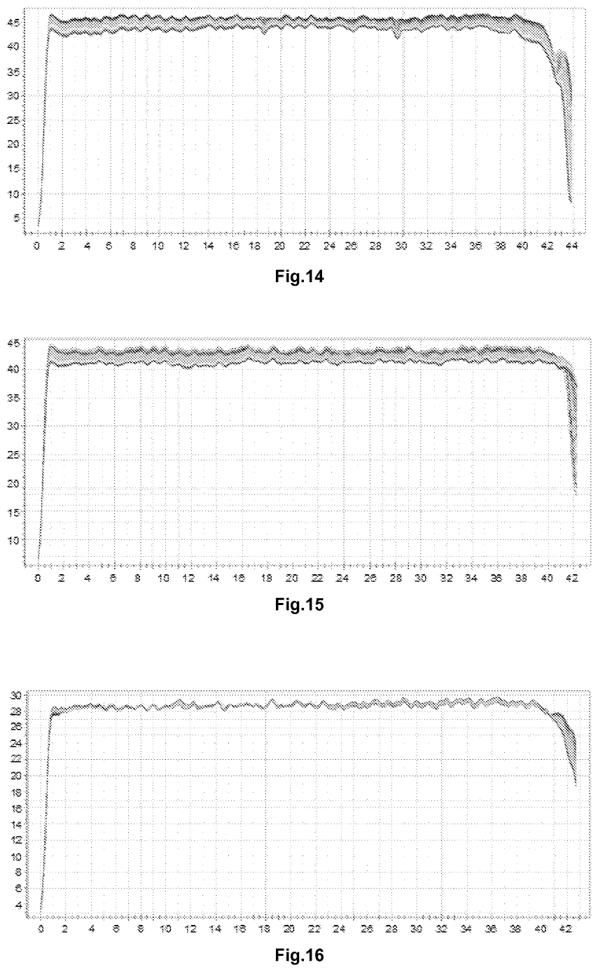

Spectra obtained after different periods of time, up to a duration of 24 h, are shown in FIG. 13, FIG. 14, FIG. 15, and FIG. 16.

There is no change in the backscattering of light between the initial dispersion and the aged dispersions, either at low or high temperature: the dispersions have not settled, same have good thermal stability.

### Example 5

The filtration properties of a fermented cane molasses comprising approximately 55% by weight of dry matter were tested according to the protocol described in the standard API RP 13B. A volume of fermented molasses, preheated to 60° C., was filtered in a filtration cell of the company Ofite under a pressure of 0.6-0.7 MPa for 30 minutes. The filter was a cellulose ester membrane. Two filters with different pore sizes were used: a filter with a pore size of 1.2 μm and a filter with a pore size of 7-10 μm.

The filtrates recovered from the test (i.e. the fluids crossing the membrane) were quantified and the filter cakes were observed by optical microscopy.

Whatever the filter used, the quantity of filtrates obtained is small. With the 1.2 μm pore size filter, 10.6 g of filtrates were collected, whereas with the 7-10 μm pore size filter, only 1.1 g of filtrates were obtained.

Observation of the cakes under an optical microscope revealed that the cakes are enriched in solid particles (especially cellulose).

The results demonstrate that fermented molasses has a good capacity for clogging and for the formation of films of reduced permeability.

### Example 6

A dispersion comprising 30% by weight of barite and 70% by weight of fermented molasses was prepared as follows: a quantity of 20.6 g dry weight of barite powder was added to a quantity of 48 g molasses fermented with magnetic stirring (using a magnetic bar) at 1200 rpm for 3 minutes at room temperature. The fermented molasses used is a fermented cane molasses comprising about 55% by weight of dry matter. No other compound was added to the composition.

The filtration properties of the composition were evaluated as described in example 5 hereinabove.

When the filter with a pore size of 1.2 μm was used, no filtrate was recovered. With the 7-10 μm pore size filter, only traces of filtrates were collected.

The cakes formed on the filters, observed by optical microscopy, are enriched in solid particles, more particularly barite and cellulose from fermented molasses.

The results show that compositions comprising a filler such as barite still have better sealing and impermeability properties than compositions comprising fermented molasses alone.

The results also suggest that such a composition used as a drilling mud would minimize or even prevent fluid losses through the walls of subterranean formations.

1. A composition comprising a fermented molasses and at least one colloidal filler having a density greater than or equal to 1.8 at 20° C.

2. The composition according to claim 1, wherein the fermented molasses is fermented beet molasses and/or fermented cane molasses.

3. (canceled)

4. The composition according to claim 1, wherein the colloidal filler is chosen from the group consisting of barite, calcium carbonate, carbon black, pigments, calcium sulfate, iron oxide, titanium dioxide, fruit core powders, kaolin, colloidal silica particles, talc, clays, lime, magnesium oxide, aluminum oxide, yeast walls, and combinations thereof.

5. The composition according to claim 1, wherein the at least one colloidal filler has a density greater than or equal to 2.5 at 20° C.

6. The composition according to claim 1, wherein the at least one colloidal filler has a density greater than or equal to 4 at 20° C.

7. The composition according to claim 1, comprising from 35 to 80% by weight, of fermented molasses and/or comprising from 20 to 65% by weight of colloidal filler having a density greater than or equal to 1.8, with respect to the total mass of the composition.

8. (canceled)

9. The composition according to claim 1, further comprising a water content from 20 to 70% by weight, with respect to the total mass of the composition.

10. The composition according to claim 1, wherein the fermented molasses comprises a dry matter content of 50 to 90% by weight.

11. The composition according to claim 1, further comprising at least one brine.

12. The composition according to claim 1, having a pH of 2 to 12.5.

13. The composition according to claim 1, which is a drilling mud, a detergent composition, or a pigment paste.

14. (canceled)

15. (canceled)

16. (canceled)

17. A method for coating on a surface comprising:
supplying a fermented molasses composition comprising at least 35% by weight of fermented molasses dry matter; and
applying the composition over the surface.

18. The method according to claim 17, wherein the coating is a film reducing the permeability to a substance chosen from the group consisting of water, gases, greases and combinations thereof.

19. The method according to claim 17, wherein the fermented molasses is fermented beet molasses and/or fermented cane molasses.

20. The method according to claim 17, wherein the quantity of fermented molasses dry matter, relative to the total weight of the fermented molasses composition, is from 40 to 90% by weight, preferably from 50 to 65% by weight and/or wherein the fermented molasses composition has a concentration of water greater than or equal to 10% by weight.

21. (canceled)

22. The method according to claim 17, wherein the fermented molasses composition comprises from 20 to 40% by weight of at least one colloidal filler.

23. The method according to claim 17, wherein the fermented molasses composition consists of fermented molasses dry matter and water.

24. The method according to claim 17, wherein the fermented molasses composition has a pH of 2 to 13.

25. The method according to one of claims 17 to 24, wherein the surface is a surface of a rock of subterranean formation or wherein the surface is made of hydraulic binder, or wherein the surface is made of a material comprising cellulose fibers.

26. (canceled)

27. (canceled)

28. An object coated at least partly with a coating comprising at least 35% by weight of fermented molasses dry matter.
